(19) United States
(12) Patent Application Publication
(10) Pub. No.: US 2026/0032528 A1
(43) Pub. Date: Jan. 29, 2026

(54) RADIO RESOURCE MANAGEMENT AND CELL RESELECTION FOR NETWORK SLICE ACCESS STRATUM GROUP IDENTIFIERS SHARED BY TRACKING AREAS

(71) Applicant: Apple Inc., Cupertino, CA (US)

(72) Inventors: Yuqin Chen, Beijing (CN); Peng Cheng, Beijing (CN); Fangli Xu, Beijing (CN); Haijing Hu, Los Gatos, CA (US)

(21) Appl. No.: 18/996,999

(22) PCT Filed: Jul. 11, 2023
(86) PCT No.: PCT/US2023/027311

§ 371 Date: Jan. 18, 2025

Related U.S. Application Data
(60) Provisional application No. 63/394,262, filed on Aug. 1, 2022.

(51) Int. Cl. H04W 36/00; H04W 36/08

(52) U.S. Cl. CPC H04W 36/0061; H04W 36/008357; H04W 36/08

(57) ABSTRACT

Systems, methods, and circuitries are provided for performing network slice-based prioritization. In one example a UE is configured to receive a non-access stratum (NAS) message configuring one or more network slicing access stratum groups (NSAGs) and providing NSAG priority information. The UE receives a release message that indicates first NSAG/frequency priority information for a first set of one or more NSAG/frequency pairs. The UE receives system information that indicates second NSAG/frequency priority information for a second set of one or more NSAG/frequency pairs. The UE prioritizes frequencies that are included in at least one NSAG/frequency pair belonging to both the first set and the second set while not considering frequencies that are not included an NSAG-frequency pair belonging to both the first set and the second set. The UE performs radio resource management measurements or cell reselection based on the prioritized frequencies.

### REFERENCE TO RELATED APPLICATIONS

This application claims the benefit of U.S. Provisional Application No. 63/394,262, filed on Aug. 1, 2022, the contents of which are hereby incorporated by reference in their entirety

### BACKGROUND

Network slicing refers to the selection and allocation of network resources to suit the requirements of a specific service. For example, some applications are likely to require high throughputs and a UE application using such a service should be allocated a network slice including network resources that support high throughputs. In contrast, other applications require low latency and should be allocated different network resources that are optimized for low latency. Quality of service (QOS) for various UEs and applications may also be a consideration in selecting network slices for different services.

### BRIEF DESCRIPTION OF THE DRAWINGS

Some examples of circuits, apparatuses and/or methods will be described in the following by way of example only. In this context, reference will be made to the accompanying Figures.

FIG. 1 schematically illustrates cell reselection according to frequency priority, in accordance with various aspects disclosed.

FIG. 2 illustrates an example communication network, in accordance with various aspects disclosed.

FIG. 3 is message flow diagram illustrating an example exchange of messages related to slice based prioritization, according to various aspects disclosed.

FIGS. 4A and 4B are flow diagrams illustrating example methods for slice group based frequency prioritization, according to various aspects disclosed.

FIG. 5 is a flow diagram illustrating an example method for slice group based frequency prioritization, according to various aspects disclosed.

FIG. 6 illustrates an example of an infrastructure equipment, in accordance with various aspects disclosed.

FIG. 7 illustrates an example of a UE platform, in accordance with various aspects disclosed.

### DETAILED DESCRIPTION

The present disclosure is described with reference to the attached figures. The figures are not drawn to scale and they are provided merely to illustrate the disclosure. Several aspects of the disclosure are described below with reference to example applications/use cases for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

Cell reselection is a process by which a UE reselects a serving cell to obtain an improved channel state. Cell reselection may be in response to UE motion, changes in channel conditions, network re-prioritization of channels, and so on. To facilitate cell reselection the UE performs radio resource management (RRM) measurements on reference signals transmitted by the serving cell and also nearby cells. In one example the reference signals measured for RRM purposes include synchronization signal/physical broadcast channel block (SSB) signals. In one example, the measurement quantity used for cell reselection is the reference signal received power (RSRP). In other examples, not described herein, the measurement quantity used for cell reselection is the reference signal received quality (RSRQ). Other reference signals and measurement quantities may be used for RRM measurement or cell reselection.

In order to control the reselection process (e.g., for load balancing) the network assigns a priority to each frequency that may be used for communication by the UE. For example, if the network assigns a higher priority to F1 than F2, then the probability that the UE will select F1 for communication is increased. Priority information for the different frequencies is broadcast by way of system information blocks (SIBs) (e.g., SIB16) or may be provided to a specific UE through a radio resource control (RRC) connection release message. The UE-specific frequency priority information in the RRC connection release message is given precedence by the UE over the SIB16 frequency priority information.

FIG. 1 provides an overview of a cell reselection process. In the illustrated example, an IDLE UE is camped on cell 110 (shown in dashed line). The frequency priority information the UE has received from SIB16 and/or an RRC connection release message affects which frequencies are measured by the UE for RRM purposes. For example, the UE may always perform measurement on a higher priority frequency as compared to the priority of the serving frequency, regardless of the channel quality of the serving cell. Frequencies that have a priority equal to or lower than the serving frequency priority may not be measured or may be measured only when certain conditions are met, such as the channel quality of the serving cell falling below a threshold, to conserve power. Further, the RRM measurement and cell-reselection processes includes a set of thresholds that favor measurement or cell reselection in the same frequency (intra-frequency) as compared to cell reselection to a different frequency (inter-frequency).

In one example, the UE camping in cell 110 will make RRM measurements on SSBs on F1 cell 2 110 (the serving cell) and as long as the channel quality is above an intra-frequency measurement threshold, the UE does not make RRM measurements on F1 cell1 120 or F2 Cell1 130, which are of equal or lower priority. If a higher priority frequency has been identified (e.g., F3 cell1 140) the UE will make RRM measurements on that frequency even when the channel quality of the serving cell is above the intra-frequency measurement threshold. If the serving cell channel quality falls below the intra-frequency measurement threshold but remains above an inter-frequency measurement threshold that is lower than the intra-frequency measurement threshold, the UE will additionally measure F1 cell1 120. If the channel quality falls below the inter-frequency measurement threshold the UE will additionally measure and F2 cell1 130.

To determine whether to switch cells, the UE ranks the measured cells according to frequency priority and then compares the RSRP of any higher priority frequency cells (as compared to the priority of the serving cell) with a priority-based reselection threshold and if the RSRP exceeds this priority-based threshold, the UE will select the higher priority frequency cell for camping, regardless of the RSRP of the serving cell. For equal or lower priority frequency cells, the UE will compare the RSRP for each cell with the RSRP of the serving cell and perform cell reselection based on the differences in RSRP as compared to various thresholds and frequency priorities. As with RRM measurements, the cell-reselection process generally favors intra-frequency cell reselection. Thus, the intra-frequency reselection threshold is higher than the inter-frequency reselection threshold. The specific cell-reselection process will not be described in detail for the sake of brevity.

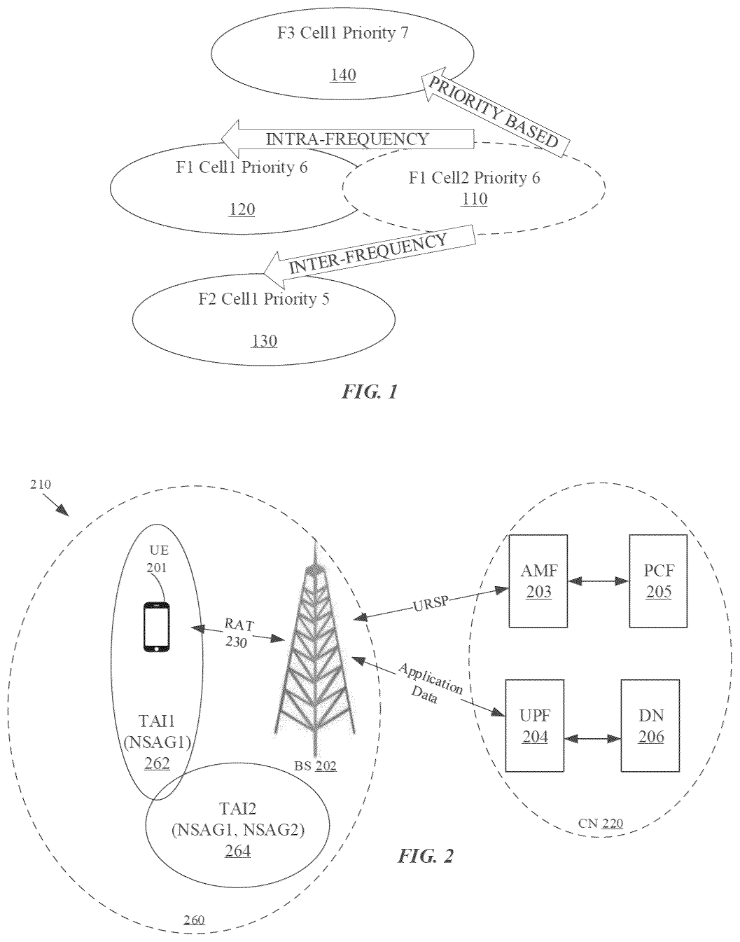

Based on a given UE's data handling requirements (e.g., UE capabilities, active applications, and so on) in addition to prioritizing certain frequencies, the network may identify preferred network slices for the UE. Network slice priority is also taken into account by the UE for RRM measurements and cell reselection. FIG. 2 shows an exemplary wireless communication system supporting network slicing for a UE 201. The wireless communication system can be a 5G new radio (NR) network including the UE 201, base station (BS) 222, an access and mobility management function (AMF) 203, a policy control function (PCF) 205, a user plane function (UPF) 204, and a data network (DN) 206. The UE 201 and BS 202 are part of a radio access network (RAN) 210. The AMF 203, PCF 205, UPF 204, and DN 206 are part of a core network (CN) 220. The CN 220 may be considered as including network nodes associated with a control plane (e.g. AMF 203 and PCF 205) and network nodes associated with a user plane (e.g., UPF 204 and DN 206). The UE 201 can be a smart phone, a wearable device, an Internet of Things (IOT) device, a tablet, and the like. The BS 202 can be a 5G gNB, 4G LTE eNB, and the like.

In the access stratum (AS) layer, the RAN 210 can provide radio access for the UE 201 via a radio access technology (RAT) 230 such as Bluetooth, WiFi, GSM, UMTS, LTE, or 5G NR. In non-access stratum (NAS) the AMF 203 can communicate with the BS 202 or the RAN 210 to manage the connections of the UEs in the communication network. The PCF 205 can provide access and mobility management related policies to the AMF 203. The UPF 204 can communicate with the BS 202 or the RAN 210 and the DN 206 can communicate with the UPF 204.

Data traffic can be delivered in internet protocol (IP) packets, such as a protocol data unit (PDU) session. The PDU session defines an association between a UE (e.g., UE 201) and the DN 106 that provides a PDU connectivity service. The PDU connectivity service provides exchange of PDUs between the UE and the DN 206. Each PDU session can include a PDU session ID and one or more QoS flows and QoS rules.

When a connected UE triggers an application, outgoing traffic associated with the application can be routed through a network slice according to a UE route selection policy (URSP) that is determined by the PCF 205 and provided to the UE by the AMF 203. The URSP includes URSP rules that define how different types of traffic are to be routed, for example through which network slices. According to the URSP, the outgoing traffic can be routed to an established PDU session, may be offloaded to a non-3GPP access outside a PDU session, or a new PDU session may be established for the outgoing traffic. It is noted that the same network slice may support more than one PDU session.

Network slicing access stratum groups (NSAGs) may be dynamically configured by the network to include a plurality of network slices, each of which may be uniquely identified by a single network slice selection assistance information (S-NSSAI) identifier. NAS messages for a UE may refer to NSAGs rather than individual network slices to reduce signaling overhead. NAS messages are used to configure NSAG priority for a UE. In one example NSAGs are configured by a Registration Accept message or UE Configuration Command message for a public land mobile network (PLMN). The terms NSAG and slice group may be used herein interchangeably.

To reduce the signaling overhead associated with indicating NSAGs, the number of NSAG identifiers is limited (e.g., no more than 4). The NSAG identifiers (referred to hereinafter as NSAGs) are reused for different tracking areas. Tracking areas (e.g., 262, 264) identify groups of cells within a registration area 260 between which the UE may move without notifying the network. An NSAG for a first tracking area (tracking area identifier (TAI) 1) may include different network slices than the same NSAG in a different tracking area TAI2. Thus, the TAI for an NSAG should be taken into consideration during RRM measurements and cell reselection. In some examples, unique NSAG is identified in the NAS message and the system information using a combination of an NSAG identifier that is unique to a specific tracking area and a tracking area identifier (TAI) for the specific tracking area.

Described herein are systems, methods, and circuitries that facilitate RRM measurement and cell reselection based on NSAG priority information.

### Serving Cell NSAG Support Information in System Information

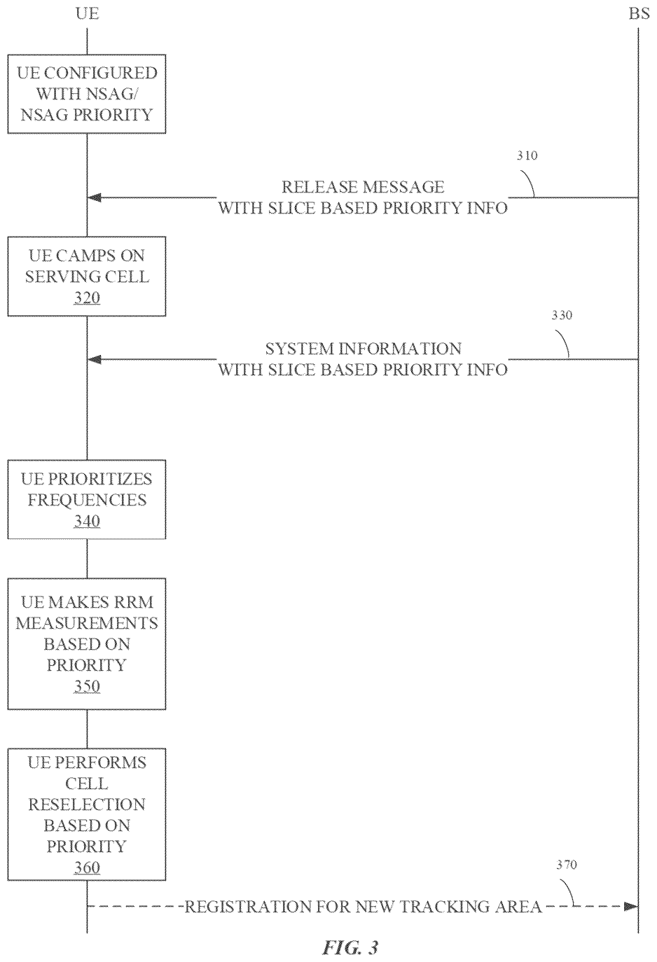

FIG. 3 is message flow diagram that provides an overview of slice group based prioritization for RRM measurement and cell reselection. A UE connected to a BS has been configured, by way of an NAS message or messages (e.g., during registration with the BS), with one or more NSAGs and corresponding NSAG priorities. When the UE is transitioning to IDLE mode, at 310 the BS transmits a release message (e.g., an RRCRelease message) that confirms that the UE may enter IDLE mode. The release message includes NSAG-frequency priority information that, for each of a plurality of NSAG-frequency pairs, indicates an NSAG-frequency priority. For example, the RRCRelease message may include an IE freqPriorityDedicatedSlicing that indicates NSAG-frequency priority. The NSAG-frequency priority information received by the UE by way of the release message will be given precedence by the UE over NSAG-frequency priority information received by way of system information.

At 320, the IDLE UE camps on a serving cell provided by the BS. The IDLE UE is configured with NSAG priority information from the NAS message and NSAG-frequency priority information from the release message. At 330, the network uses system information to configure slice group availability for neighboring cells, on a per frequency basis. For example, the system information may be a system information block SIB16 that includes an IE cellReselectionPriorities or freqPriorityListNRSlicing that indicates NSAG-frequency priority. SIB16 indicates, for each NSAG-frequency pair, an NSAG-frequency priority, a list of slice allowed cells that support the slice group, and a list of slice excluded cells that do not support the slice group. However, the SIB16 does not currently indicate the slice group availability for the serving cell for each NSAG-frequency pair.

At 340, the IDLE UE prioritizes frequencies for RRM measurement and cell reselection. Generally speaking, frequency prioritization is performed based first on slice group priority and then based on frequency priority within frequencies that support the highest priority slice group. TS 38.304 outlines the process utilized by the UE to prioritize frequencies for RRM measurement and cell reselection purposes. TS 38.304 can be summarized as follows. Frequencies that support at least one prioritized NSAG (NSAG priority provided by NAS message to UE) have higher priority than frequencies that support none of the NSAGs provided by the NAS message. Frequencies that support a least one NSAG provided by the NAS message are prioritized in order of the NAS provided NSAG-frequency priority. Frequencies with equal NSAG-frequency priority are prioritized in order of their slice group specific cell reselection priority (which may be configured in system information). Frequencies that do not have a slice group specific cell reselection priority are prioritized below frequencies that have a slice group specific cell reselection priority. Frequencies that support none of the NSAGs provided by the NAS message are prioritized in order of their cell reselection priority.

Recall that the system information (e.g., SIB16) does not currently provide information regarding whether the serving cell supports a given NSAG. If the UE has not been provided with information about which NSAGs the serving cell supports, the UE may perform RRM measurements and/or cell reselection based on NSAG-frequency priority information for the serving frequency implicitly assuming that the serving cell supports all NSAGs. This may cause a UE that is camping on a cell that does not support a high priority NSAG-frequency to refrain from reselecting to a cell that supports the high priority NSAG-frequency. When the UE accesses the cell for the high priority NSAG, service will not be available.

To improve cell reselection, system information (e.g., SIB16) may be modified to also indicate the NSAG availability for the serving cell for each NSAG-frequency pair in the same manner the SIB16 indicates this information for neighbor cells. With this approach, if SIB16 includes the serving cell in the list of slice allowed cells the UE determines that the serving cell supports the NSAG-frequency pair. If SIB16 does not include the serving cell in either the list of slice allowed cells or the list of slice excluded cells for a given NSAG-frequency pair, the UE assumes that the serving cell supports the given NSAG-frequency pair. In this manner, the UE may consider NSAG availability for the serving frequency in frequency prioritization and avoid camping on a cell that does not support a high priority NSAG.

At 350 the UE makes RRM measurements based on the NSAG priority information and NSAG-frequency priority information and at 360, the UE performs cell reselection based on the NSAG priority information and NSAG-frequency priority information. If a cell outside the UE's current tracking area (TA) is selected, the UE may register the UE's new TA with the BS at 370. New NAS messages may be provided to the UE with NSAG configuration and priority information as part of the registration process.

To implement the above outlined solution, the following changes may be made to 3GPP TS 38.331.

FreqPrioritySlicing field descriptions

dl-ImplicitCarrierFreq
Indicates the downlink carrier frequency to which sliceInfoList is associated with.
The frequency is signalled implicitly, value 0 corresponds to the serving frequency,
value 1 corresponds to the first frequency indicated by the InterFreqCarrierFreqList
in SIB4, and value 2 corresonds to the second frequency indicated by the
InterFreqCarrierFreqList in SIB4, and so on.

SliceInfo field descriptions

nsag-IdentityInfo
This is the NSAG identifier of the NSAG.
SliceAllowedCellListNR
List of allow-liested neighbouring cells and serving cell for slicing. If present, cells
not listed in the list do not support the corresponding nsag-frequency pair,
according to 38.304[20], clause 5.2.4.11.
SliceCellListNR
Contains either the list of allow-listed or exclude-listed neighbour cells and serving
cell for slicing.
sliceExcludedCellListNR
List of exclude-listed neigbouring cells and serving cell for slicing. If present, cells
not listed in this list support the corresponding slice nsag-frequency pair, according
to 38.304[20], clause 5.2.4.11.

### Consideration of NSAGs Outside Current Tracking Area

As just discussed, a UE takes NSAG priority into account when prioritizing frequencies for RRM measurement and cell reselection. The UE receives NSAG priority information from the NAS message, which includes NSAG identifiers (e.g., an nsag-ID IE). The UE then prioritizes frequencies and cells based on which frequencies and cells support the highest priority NSAG and the next highest priority NSAG, and so on. However, while the NAS message indicates a TAI for each NSAG, the TAI information is not indicated to the UE AS layer under the current specification and thus this layer does not consider the TAI information for prioritization purposes.

Currently, the frequency prioritization outlined in TS 38.304 5.2.4.11 specifies that the UE considers a frequency as supporting all slices of an NSAG if the corresponding NSAG identifier is indicated for the NR frequency and the NSAG identifier is valid for the TAI in which the UE is currently located. In one example, in system information (e.g., SIB16) the NSAG identifier is indicated for the NR frequency in the IE FreqPriorityListSlicing and, in the release message, the NSAG identifier is indicated for the NR frequency in the IE FreqPriorityListDedicatedSlicing.

The network may configure a slice allowed list and/or slice excluded list. When the network configures the list(s), the UE considers a cell on a frequency as supporting all slices of an NSAG if the corresponding NSAG identifier is indicated for the NR frequency and the NSAG identifier is valid for the TAI in which the UE is currently located and the cell is either listed in the slice allowed cell list (e.g., the sliceAllowedCellListNR IE) or the cell is not listed in the slice excluded cell list (e.g., the sliceExcludedCellListNR IE). If the network does not configure a slice allowed list or slice excluded list, then the UE assumes that all cells support each NSAG. Note, that according to this process, the UE does not consider any frequency or cell for an NSAG that is valid outside the UE's current tracking area. Further, the consideration of NSAGs in TAIs outside the current tracking area is prevented because the TAI information for NSAGs included in the NAS message is not indicated to the UE AS layer.

Referring to FIG. 2, under the current formulation of TS 38.304, as the UE 201 which is camping in TAI1 262 moves into a border region between TAI1 and TAI2 264, the UE will not consider frequencies or cells in TAI2 for RRM measurement or cell reselection, even though TAI2 264 supports NSAG1. Further, even if NSAG 2 has a higher priority, the UE 201 would remain camped in TAI1 262 because the UE would not consider frequencies/cells in TAI2 until the UE moves into TAI2 264. This degrades the RRM measurement and/or cell reselection process causing a UE to remain camped in a cell that does not better align with the network's priorities.

To improve slice group based prioritization, the UE NAS layer may provide a valid TAI for each configured NSAG identifier to the UE AS layer for prioritization purposes. In this manner, multiple slice groups that share a same NSAG identifier but that are valid in different TAIs may be considered for prioritization by the UE. The UE's slice group based prioritization process may be modified so that the UE considers frequencies and cells outside the UE's current TAI. Further, if the UE is aware, based on the NAS message, priorities for NSAG-TAI pairs, rather than simply NSAGs, frequencies that don't support a high priority NSAG-pair will not be prioritized for RRM measurements, saving the overhead associated with such measurements.

To facilitate the use of NSAG-TAI based prioritization, system information may also indicate NSAG ID and TAI rather than simply NSAG ID. However, if system information does not indicated NSAG ID and TAI, a UE may use information in SIB1 or SIB16 to derive a TAI for the serving cell, albeit not for neighbouring cells.

In one example, the above described solution may be implement by the following changes to TS 38.304:

| RRC_IDLE and | | |
|---|---|---|
| RRC_INACTIVE | | |
| state Process | UE Non-Access Stratum | UE Access Stratum |
| Cell Reselection | For a UE not operating in SNPN | Perform measurements |
| | access mode, maintain a list of | needed to support cell |
| | equivalent PLMN identities and | reselection. |
| | provide the list to AS. | Detect and synchronise |
| | Maintain a list of “Forbidden | to a broadcast channel. |
| | Tracking Areas” and provide list to | Receive and handle |
| | AS. | broadcast information. |
| | For a UE not operating in SNPN | Forward NAS system |
| | access mode, maintain Allowed | information to NAS. |
| | CAG list and optional CAG-only | Change cell if a more |
| | indication along with associated | suitable cell is found. |
| | PLMN ID(s) on which the UE is | Derive cell reselection |
| | allowed access and provide these | priorities for slice-based |
| | lists to AS. | cell reselection. |
| | Maintain slice information including | |
| | NSAG(s) and corresponding valid | |
| | TAI(s) and their priorities and | |
| | provide this information to AS. | |

The following change may also be made to TS 38.304:

### 5.2.4.11 Reselection Priorities for Slice-Based Reselection

The UE derives re-selection priorities for slice-based cell re-selection by using:
NSAGs and corresponding valid TAI(s) and their priorities provided by NAS,
sliceInfoList and/or sliceInfoListDedicated per frequency with nsag-CellReselectionPriority per NSAG, if provided in system information and/or dedicated signalling,
cellReselectionPriority per frequency provided in system information and/or dedicated signalling.

The UE considers an NR frequency to support all slices of an NSAG if
the corresponding nsag-ID and corresponding valid TAI(s)_is indicated for the NR frequency.

The UE considers a cell on an NR frequency to support all slices of an NSAG if
the corresponding nsag-ID and corresponding valid TAI(s) is indicated for the NR frequency; and
the cell is either listed in the sliceAllowedCellListNR (if provided in the used slice specific cell reselection information) or the cell is not listed in the sliceExcludedCellListNR (if provided in the used slice specific cell reselection information); or
neither sliceAllowedCellListNR or sliceExcludedCellListNR is configured in the used slice specific cell reselection information.

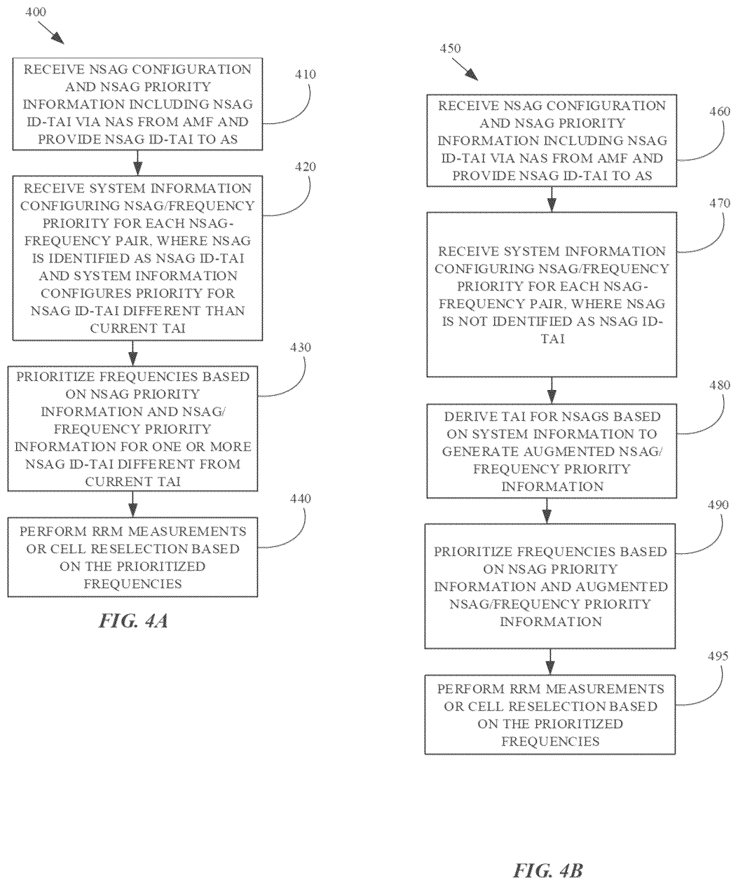

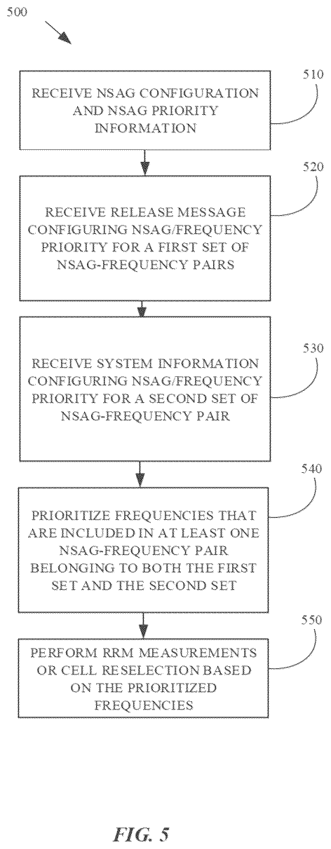

FIG. 4A outlines an example method 400 for performing slice group based prioritization. The method 400 may be performed by a UE, or more specifically, by a baseband processor of a UE. The method includes, at 410, receiving a non-access stratum (NAS) message configuring one or more network slicing access stratum groups (NSAGs). The NAS message provides NSAG priority information, in which each NSAG in the NAS message is identified by a combination of an NSAG identifier that is unique to a specific tracking area and a tracking area identifier (TAI) for the specific tracking area. The NSAG priority information, including the TAI for each configured NSAG is provided to the AS layer of the UE. At 420, system information is received that indicates NSAG/frequency priority information for each of one or more NSAG-frequency pairs. In the system information, each NSAG in the system information is identified by a combination of an NSAG identifier that is unique to a specific tracking area and a TAI for the specific tracking area. The system information indicates NSAG/frequency priority information for one or more NSAGs identified by a combination of an NSAG identifier and a TAI that is different than a current TAI for the UE.

At 430, the method includes prioritizing frequencies based on the NSAG priority information and the NSAG/frequency priority information for the one or more NSAGs identified by the combination of the NSAG identifier and the TAI that is different than the current TAI. Radio resource management (RRM) measurements or cell reselection based on the prioritized frequencies are performed at 440.

FIG. 4B outlines an example method 450 for performing slice group based prioritization when system information does not indicate TAI for NSAG IDs. The method 450 may be performed by a UE, or more specifically, by a baseband processor of a UE. The method includes, at 460, receiving a NAS message configuring one or more NSAGs. The NAS message provides NSAG priority information, in which each NSAG in the NAS message is identified by a combination of an NSAG identifier that is unique to a specific tracking area and a TAI for the specific tracking area. The NSAG priority information, including the TAI for each configured NSAG is provided to the AS layer of the UE. At 470, system information is received that indicates NSAG/frequency priority information for each of one or more NSAG-frequency pairs. The system information indicates NSAG/frequency priority information for one or more NSAGs identified by an NSAG identifier without indicating a TAI in which the NSAG identified by the NSAG identifier is valid.

At 480, the method includes deriving a TAI for at least one of the one or more NSAGs based on the system information to generate augmented NSAG/frequency priority information.

At 490, the method includes prioritizing frequencies based on the NSAG priority information and the augmented NSAG/frequency priority information for the one or more NSAGs identified by the combination of the NSAG identifier and the TAI that is different than the current TAI. Radio resource management (RRM) measurements or cell reselection based on the prioritized frequencies are performed at 495.

### Release Message Frequency Priorities Moot When UE Moves to Non-supporting Cell

When a UE transitions to the IDLE state, the release message (e.g., RRCRelease message) configures NSAG/frequency priority for one or more NSAG ID TAI-frequency pairs (e.g., using IEs cellReselectionPriorities or freqPriorityListNRSlicing). This priority information from the release message takes precedence over priority information received in system information. If the UE moves to a cell not supporting the NSAG-TAI prioritized NSAG-TAI in the release message, the UE would still consider the frequency as prioritized by the release message and may make unnecessary RRM measurements.

To avoid such unnecessary RRM measurements, the UE may be configured to consider, for prioritization purposes, only frequencies that are identified as supporting a given NSAG ID-TAI in both the release message and system information.

For example, a UE receives the following NSAG/frequency priority information in an RRCRelease message freqPriorityListNRSlicing IE:
F1: supporting NSAG1-TAI1, frequency priority
F2: supporting NSAG2-TAI2, frequency priority

The UE receives the following NSAG/frequency priority information in system information for a camping cell (e.g., via SIB16 freqPriorityListNRSlicing IE):
F1: NSAG1-TAI, allowed cell list/excluded cell list
F2: NSAG3, allowed cell list/excluded cell list

In this example, the UE would only consider F1 for NSAG1-TAI1 and not F2 for frequency prioritization purposes when the UE camps on the serving cell.

In one example, TS 38.304 5.2.4.1 may be modified to include the following to implement the above described solution:

The UE shall only perform slice specific cell reselection evaluation for NR frequencies supporting the NSAG and corresponding TAI as received RRCRelease message and that are also given in system information.

FIG. 5 is a flow diagram outlining a method 500 for performing slice group based prioritization. The method 500 may be performed, for example by a UE (such as UE 201 of FIG. 2) or, more specifically a baseband processor of a UE. The method includes, at 510, receiving a non-access stratum (NAS) message configuring one or more network slicing access stratum groups (NSAGs) and also indicating NSAG priority information. At 520, a release message is received confirming a transition by the UE from a connected state to an idle state, wherein the release message indicates first NSAG/frequency priority information for a first set of one or more NSAG-frequency pairs. System information that indicates second NSAG/frequency priority information for a second set of one or more NSAG-frequency pairs is received at 530. The method includes, at 530 prioritizing frequencies that are included in NSAG/frequency pairs belonging to the first set and the second set while not considering frequencies that are not included an NSAG/frequency pair belonging to both the first set and the second set. The prioritization is performed based on the NSAG priority information, the first NSAG/frequency priority information, and the second NSAG/frequency priority information. At 550, the method includes performing radio resource management measurements or cell reselection based on the prioritized frequencies.

It can be seen from the foregoing description that including TAI with NSAG IDs in NAS messages and configuring a UE to consider cells and frequencies for NSAGs supported by nearby TAIs improves cell reselection. Further, configuring a UE to only consider slice group-frequency pairs included in both a release message and system information prevents performance of potentially unnecessary RRM measurements.

In this description and the appended claims, use of the term determine with reference to some entity (e.g., parameter, variable, and so on) in describing a method step or function is to be construed broadly. For example, determine is to be construed to encompass, for example, receiving and parsing a communication that encodes the entity or a value of an entity. Determine should be construed to encompass accessing and reading memory (e.g., lookup table, register, device memory, remote memory, and so on) that stores the entity or value for the entity. Determine should be construed to encompass computing or deriving the entity or value of the entity based on other quantities or entities. Determine should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. Derive should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. Derive should be construed to encompass computing or calculating the entity or value of the entity based on other quantities or entities. Derive should be construed to encompass any manner of deducing or identifying an entity or value of the entity.

As used herein, the term indicate, when used with reference to a value of an entity or parameter is to be construed broadly as any manner of communicating the value of the entity or parameter. Indicate should be construed to encompass encoding the indicated information in bit values that are transmitted in a message to another processor. For example, indicating may be performed by providing a bit value in a message that is mapped by the receiver to a corresponding value or parameter setting based on pre-configured values stored in the receiver or provided to the receiver in prior or subsequent messages. Indicating may also be performed by refraining from explicitly communicating a value, such that the lack of bits encoding first information is interpreted as an indication of second information by the receiver.

Use of the word exemplary is intended to present concepts in a concrete fashion. The terminology used herein is for the purpose of describing particular examples only and is not intended to be limiting of examples. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. As used herein the term “or” includes the option of all elements related by the word or. For example A or B is to be construed as include only A, only B, and both A and B. Further the phrase “one or more of” followed by A, B, or C is to be construed as including A, B, C, AB, AC, BC, and ABC.

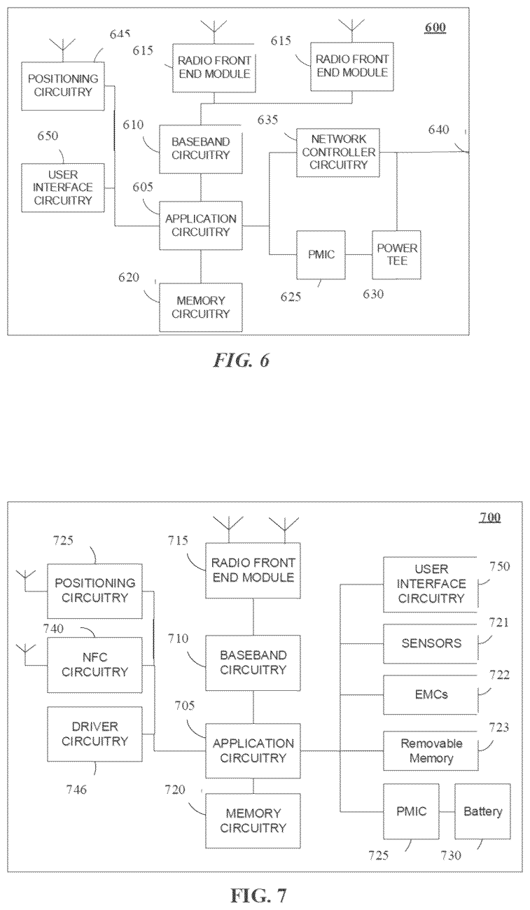

FIG. 6 illustrates an example of infrastructure equipment 600 in accordance with various aspects. The infrastructure equipment 600 (or “system 600”) may be implemented as a base station, radio head, RAN node such as the BS 202 of FIG. 2 and/or any other element/device discussed herein. In other examples, the system 600 could be implemented in or by a UE, such as UE 201 of FIG. 2.

The system 600 includes application circuitry 605, baseband circuitry 610, one or more radio front end modules (RFEMs) 615, memory circuitry 620, power management integrated circuitry (PMIC) 625, power tee circuitry 630, network controller circuitry 635, network interface connector 640, satellite positioning circuitry 645, and user interface circuitry 650. In some aspects, the device 600 may include additional elements such as, for example, memory/storage, display, camera, sensor, or input/output (I/O) interface. In other aspects, the components described below may be included in more than one device. For example, said circuitries may be separately included in more than one device for CRAN, vBBU, or other like implementations.

Application circuitry 605 includes circuitry such as, but not limited to one or more processors (or processor cores), cache memory, and one or more of low drop-out voltage regulators (LDOs), interrupt controllers, serial interfaces such as SPI, 12C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 605 may be coupled with or may include memory/storage elements and may be configured to execute instructions stored in the memory/storage to enable various applications or operating systems to run on the system 600. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 605 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some aspects, the application circuitry 605 may comprise, or may be, a special-purpose processor/controller to operate according to the various aspects herein. As examples, the processor(s) of application circuitry 605 may include one or more Apple® processors, Intel® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some aspects, the system 600 may not utilize application circuitry 605, and instead may include a special-purpose processor/controller to process IP data received from an EPC or 5 GC, for example.

User interface circuitry 650 may include one or more user interfaces designed to enable user interaction with the system 600 or peripheral component interfaces designed to enable peripheral component interaction with the system 600. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The components shown by FIG. 6 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

FIG. 7 illustrates an example of a platform 700 (or “device 700”) in accordance with various aspects. In aspects, the computer platform 700 may be suitable for use as UE 201 of FIG. 2, network node 202 of FIG. 2, and/or any other element/device discussed herein. The platform 700 may include any combinations of the components shown in the example. The components of platform 700 may be implemented as integrated circuits (ICs), portions thereof, discrete electronic devices, or other modules, logic, hardware, software, firmware, or a combination thereof adapted in the computer platform 700, or as components otherwise incorporated within a chassis of a larger system. The block diagram of FIG. 7 is intended to show a high level view of components of the computer platform 700. However, some of the components shown may be omitted, additional components may be present, and different arrangement of the components shown may occur in other implementations.

Application circuitry 705 includes circuitry such as, but not limited to one or more processors (or processor cores), cache memory, and one or more of LDOs, interrupt controllers, serial interfaces such as SPI, 12C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 705 may be coupled with or may include memory/storage elements and may be configured to execute instructions stored in the memory/storage to enable various applications or operating systems to run on the system 700. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

As examples, the processor(s) of application circuitry 705 may include a general or special purpose processor, such as an A-series processor (e.g., the A13 Bionic), available from Apple® Inc., Cupertino, CA or any other such processor. The processors of the application circuitry 705 may also be one or more of Advanced Micro Devices (AMD) Ryzen® processor(s) or Accelerated Processing Units (APUs); Core processor(s) from Intel® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 705 may be a part of a system on a chip (SoC) in which the application circuitry 705 and other components are formed into a single integrated circuit, or a single package.

The baseband circuitry or processor 710 may be implemented, for example, as a solder-down substrate including one or more integrated circuits, a single packaged integrated circuit soldered to a main circuit board or a multi-chip module containing two or more integrated circuits.

The platform 700 may also include interface circuitry (not shown) that is used to connect external devices with the platform 700. The external devices connected to the platform 700 via the interface circuitry include sensor circuitry 721 and electro-mechanical components (EMCs) 722, as well as removable memory devices coupled to removable memory circuitry 723.

A battery 730 may power the platform 700, although in some examples the platform 700 may be mounted deployed in a fixed location, and may have a power supply coupled to an electrical grid. The battery 730 may be a lithium ion battery, a metal-air battery, such as a zinc-air battery, an aluminum-air battery, a lithium-air battery, and the like. In some implementations, such as in V2X applications, the battery 730 may be a typical lead-acid automotive battery.

Examples can include subject matter such as a method, means for performing acts or blocks of the method, at least one machine-readable medium including instructions that, when performed by a machine cause the machine to perform acts of the method or of an apparatus or system for practicing the embodiments and examples described herein.

Example 1 is a baseband processor for a UE, configured to receive a non-access stratum (NAS) message configuring one or more network slicing access stratum groups (NSAGs), wherein an NSAG includes a plurality of network slices, wherein the NAS message provides NSAG priority information, wherein each NSAG in the NAS message is identified by a combination of an NSAG identifier that is unique to a specific tracking area and a tracking area identifier (TAI) for the specific tracking area. The baseband processor is configured to provide the NSAG priority information, including the TAI for the configured NSAGs, to an access stratum (AS) layer of the UE; receive system information indicating NSAG/frequency priority information for each of one or more NSAG-frequency pairs, wherein each NSAG in the system information is identified by a combination of an NSAG identifier that is unique to a specific tracking area and a tracking area identifier (TAI) for the specific tracking area, wherein the system information indicates NSAG/frequency priority information for one or more NSAGs identified by a combination of an NSAG identifier and a TAI that is different than a current TAI for the UE. The baseband processor is configured to prioritize frequencies based on the NSAG priority information and NSAG/frequency priority information for the one or more NSAGs identified by the combination of the NSAG identifier and the TAI that is different than the current TAI and perform radio resource management (RRM) measurements or cell reselection based on the prioritized frequencies.

Example 2 includes the subject matter of example 1, including or omitting optional elements, wherein the system information further indicates, for each of the one or more NSAG-frequency pairs, a list of cells that support an NSAG-frequency pair, and a list of cells that do not support the NSAG-frequency pair. The baseband processor is configured to determine that a serving cell supports a given NSAG-frequency pair when the serving cell is identified in the list of cells that support the NSAG-frequency pair or when the serving cell is not identified in the list of cells that do not support the NSAG-frequency pair.

Example 3 is a baseband processor for a UE, configured to receive a non-access stratum (NAS) message configuring one or more network slicing access stratum groups (NSAGs), wherein an NSAG includes a plurality of network slices, wherein the NAS message provides NSAG priority information, wherein each NSAG in the NAS message is identified by a combination of an NSAG identifier that is unique to a specific tracking area and a tracking area identifier (TAI) for the specific tracking area; provide the NSAG priority information, including the TAI for the configured NSAGs, to an access stratum (AS) layer of the UE; receive system information indicates NSAG/frequency priority information for each of one or more NSAG-frequency pairs, wherein the system information indicates NSAG/frequency priority information for one or more NSAGs identified by an NSAG identifier without indicating a TAI in which the NSAG identified by the NSAG identifier is valid. The baseband processor is configured to derive a TAI for at least one of the one or more NSAGs based on the system information to generate augmented NSAG/frequency priority information; prioritize frequencies based on the NSAG priority information and the augmented NSAG/frequency priority information; and perform radio resource management (RRM) measurements or cell reselection based on the prioritized frequencies.

Example 4 includes the subject matter of example 3, including or omitting optional elements, wherein the system information comprises SIB16.

Example 5 includes the subject matter of example 3, including or omitting optional elements, wherein the system information comprises SIB1.

Example 6 is a baseband processor for a UE, configured to receive a non-access stratum (NAS) message configuring one or more network slicing access stratum groups (NSAGs), wherein an NSAG includes a plurality of network slices, wherein the NAS message provides NSAG priority information; receive a release message confirming a transition by the UE from a connected state to an idle state, wherein the release message indicates first NSAG/frequency priority information for a first set of one or more NSAG/frequency pairs; receive system information that indicates second NSAG/frequency priority information for a second set of one or more NSAG/frequency pairs; prioritize frequencies that are included in at least one NSAG/frequency pair belonging to both the first set and the second set while not considering frequencies that are not included an NSAG-frequency pair belonging to both the first set and the second set, wherein the prioritization is performed based on the NSAG priority information, the first NSAG/frequency priority information, and the second NSAG/frequency priority information; and perform radio resource management measurements or cell reselection based on the prioritized frequencies.

Example 7 includes the subject matter of example 6, including or omitting optional elements, wherein a unique NSAG is identified in the message and the system information using a combination of an NSAG identifier that is unique to a specific tracking area and a tracking area identifier (TAI) for the specific tracking area.

Example 8 includes the subject matter of example 6, including or omitting optional elements, wherein the message comprises a radio resource configuration release (RRCRelease) message.

Example 9 includes the subject matter of example 6, including or omitting optional elements, wherein the system information comprises system information block 16 (SIB16).

Example 10 includes the subject matter of example 6, including or omitting optional elements, wherein the baseband processor is configured to, when a first NSAG/frequency priority for a given NSAG-frequency pair is provided in the release message and a second NSAG/frequency priority for the given NSAG-frequency pair is provided in the system information, prioritize the given NSAG frequency pair based on the first NSAG/frequency priority.

Example 11 is a method that includes any action or combination of actions as substantially described herein in the Detailed Description.

Example 12 is a method as substantially described herein with reference to each or any combination of the Figures included herein or with reference to each or any combination of paragraphs in the Detailed Description.

Example 13 is a user equipment configured to perform any action or combination of actions as substantially described herein in the Detailed Description as included in the user equipment.

Example 14 is a network node configured to perform any action or combination of actions as substantially described herein in the Detailed Description as included in the network node.

Example 15 is a non-transitory computer-readable medium that stores instructions that, when executed, cause the performance of any action or combination of actions as substantially described herein in the Detailed Description.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or examples of the disclosure herein. Also, one or more of the acts depicted herein may be carried out in one or more separate acts and/or phases. In some examples, the methods illustrated above may be implemented in a non-volatile computer-readable medium using instructions stored in a memory. Many other examples and variations are possible within the scope of the claimed disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A user equipment (UE), comprising:
a radio frequency (RF) transceiver;
a memory; and
a baseband processor configured to, when executing instructions stored in the memory, cause the UE to:
receive, via the RF transceiver, a non-access stratum (NAS) message configuring one or more network slicing access stratum groups (NSAGs), wherein an NSAG includes a plurality of network slices, wherein the NAS message provides NSAG priority information, wherein each NSAG in the NAS message is identified by a combination of an NSAG identifier that is unique to a specific tracking area and a tracking area identifier (TAI) for the specific tracking area;
prioritize frequencies based on the NSAG priority information; and
perform radio resource management (RRM) measurements or cell reselection based on the prioritized frequencies.

2. The UE of claim 1, wherein the baseband processor is further configured to cause the UE to:
receive, via the RF transceiver, system information indicating NSAG/frequency priority information for each of one or more NSAG-frequency pairs, wherein each NSAG in the system information is identified by a combination of an NSAG identifier that is unique to a specific tracking area and a tracking area identifier (TAI) for the specific tracking area,
wherein the system information indicates NSAG/frequency priority information for one or more NSAGs identified by a combination of an NSAG identifier and a TAI that is different than a current TAI for the UE; and
prioritize frequencies based on the NSAG priority information and NSAG/frequency priority information for the one or more NSAGs identified by the combination of the NSAG identifier and the TAI that is different than the current TAI.

3. The UE of claim 2,
wherein the system information further indicates, for each of the one or more NSAG-frequency pairs,
a list of cells that support an NSAG-frequency pair, and
a list of cells that do not support the NSAG-frequency pair,
further wherein the baseband processor is configured to determine that a serving cell supports a given NSAG-frequency pair when the serving cell is identified in the list of cells that support the NSAG-frequency pair or when the serving cell is not identified in the list of cells that do not support the NSAG-frequency pair.

4. The UE of claim 1, wherein the baseband processor is further configured to cause the UE to:
receive, via the RF transceiver, system information indicates NSAG/frequency priority information for each of one or more NSAG-frequency pairs, wherein the system information indicates NSAG/frequency priority information for one or more NSAGs identified by an NSAG identifier without indicating a TAI in which the NSAG identified by the NSAG identifier is valid,
derive a TAI for at least one of the one or more NSAGs based on the system information to generate augmented NSAG/frequency priority information; and
prioritize frequencies based on the NSAG priority information and the augmented NSAG/frequency priority information.

5. The UE of claim 4, wherein the system information comprises system information block (SIB)16 or SIB1.

6. A baseband processor for a UE, configured to perform operations comprising:
receiving a non-access stratum (NAS) message configuring one or more network slicing access stratum groups (NSAGs), wherein an NSAG includes a plurality of network slices, wherein the NAS message provides NSAG priority information, wherein each NSAG in the NAS message is identified by a combination of an NSAG identifier that is unique to a specific tracking area and a tracking area identifier (TAI) for the specific tracking area;
prioritizing frequencies based on the NSAG priority information; and
performing radio resource management (RRM) measurements or cell reselection based on the prioritized frequencies.

7. The baseband processor of claim 6, the operations further comprising:
receiving system information indicating NSAG/frequency priority information for each of one or more NSAG-frequency pairs, wherein each NSAG in the system information is identified by a combination of an NSAG identifier that is unique to a specific tracking area and a tracking area identifier (TAI) for the specific tracking area,
wherein the system information indicates NSAG/frequency priority information for one or more NSAGs identified by a combination of an NSAG identifier and a TAI that is different than a current TAI for the UE; and
prioritizing frequencies based on the NSAG priority information and NSAG/frequency priority information for the one or more NSAGs identified by the combination of the NSAG identifier and the TAI that is different than the current TAI.

8. The baseband processor of claim 7,
wherein the system information further indicates, for each of the one or more NSAG-frequency pairs,
a list of cells that support an NSAG-frequency pair, and
a list of cells that do not support the NSAG-frequency pair,
the the operations further comprising determining that a serving cell supports a given NSAG-frequency pair when the serving cell is identified in the list of cells that support the NSAG-frequency pair or when the serving cell is not identified in the list of cells that do not support the NSAG-frequency pair.

9. The baseband processor of claim 6, the operations further comprising:
receiving system information indicates NSAG/frequency priority information for each of one or more NSAG-frequency pairs, wherein the system information indicates NSAG/frequency priority information for one or more NSAGs identified by an NSAG identifier without indicating a TAI in which the NSAG identified by the NSAG identifier is valid,
deriving a TAI for at least one of the one or more NSAGs based on the system information to generate augmented NSAG/frequency priority information; and
prioritizing frequencies based on the NSAG priority information and the augmented NSAG/frequency priority information.

10. The baseband processor of claim 9, wherein the system information comprises SIB16 or SIB1.

11. A processor for a base station, configured to perform operations comprising:
causing transmission of a non-access stratum (NAS) message to a user equipment (UE) configuring one or more network slicing access stratum groups (NSAGs), wherein an NSAG includes a plurality of network slices, wherein the NAS message provides NSAG priority information, wherein each NSAG in the NAS message is identified by a combination of an NSAG identifier that is unique to a specific tracking area and a tracking area identifier (TAI) for the specific tracking area.

12. The processor of claim 11, wherein the operations further comprise
causing transmission of system information indicating NSAG/frequency priority information for each of one or more NSAG-frequency pairs, wherein each NSAG in the system information is identified by a combination of an NSAG identifier that is unique to a specific tracking area and a tracking area identifier (TAI) for the specific tracking area, and wherein the system information indicates NSAG/frequency priority information for one or more NSAGs identified by a combination of an NSAG identifier and a TAI that is different than a current TAI for the UE.

13. The processor of claim 12,
wherein the system information further indicates, for each of the one or more NSAG-frequency pairs,
a list of cells that support an NSAG-frequency pair, and
a list of cells that do not support the NSAG-frequency pair.

14. The processor of claim 11, wherein the operations further comprise:
causing transmission of system information indicates NSAG/frequency priority information for each of one or more NSAG-frequency pairs, wherein the system information indicates NSAG/frequency priority information for one or more NSAGs identified by an NSAG identifier without indicating a TAI in which the NSAG identified by the NSAG identifier is valid.

15. The processor of claim 14, wherein the system information comprises SIB16.

16-20. (canceled)
